(19) United States
(12) Patent Application Publication
(10) Pub. No.: US 2024/0250596 A1
(43) Pub. Date: Jul. 25, 2024

(54) LINEAR MOTOR, POSITIONING DEVICE, PROCESSING APPARATUS, AND DEVICE MANUFACTURING METHOD

(71) Applicant: SUMITOMO HEAVY INDUSTRIES, LTD., Tokyo (JP)

(72) Inventors: Kotaro WADA, Yokosuka-shi (JP); Tatsuya YOSHIDA, Yokosuka-shi (JP); Daisuke SHINOHIRA, Yokosuka-shi (JP); Takashi IKEDA, Yokosuka-shi (JP)

(21) Appl. No.: 18/525,741

(22) Filed: Nov. 30, 2023

(30) Foreign Application Priority Data
Jan. 25, 2023 (JP) 2023-009510

(51) Int. Cl. H02K 41/02; H02K 3/28

(52) U.S. Cl. CPC H02K 41/02; H02K 3/28; H02K 2213/03

(57) ABSTRACT

A linear motor includes a plurality of multi-phase coil groups that are arranged linearly and generate linear power in an arrangement direction depending on flowing multi-phase ACs, and inter-coil reinforcing members that are provided between the plurality of multi-phase coil groups.

### CROSS-REFERENCE TO RELATED APPLICATIONS

This application claims priority to Japanese Patent Application No. 2023-009510, filed on Jan. 25, 2023, which is incorporated by reference herein in its entirety.

### BACKGROUND

### Technical Field

Certain embodiments of the present invention relate to a linear motor and the like.

### Description of Related Art

A linear motor including three-phase coil groups that generate linear power depending on flowing three-phase ACs is disclosed in the related art. A plurality of each-phase coils (for example, a plurality of U-phase coils) are arranged adjacent to each other as a group for the purpose of ensuring insulation properties and reducing thrust ripple, and a gap (pitch) is provided between each-phase coil groups (for example, a U-phase coil group and a V-phase coil group).

### SUMMARY

Since a gap is provided between the each-phase coil groups in the related art, stiffness is reduced.

The present invention has been made on consideration of such circumstances, and it is desirable to provide a linear motor and the like in which stiffness is increased.

According to an aspect of the present invention, there is provided a linear motor including a plurality of multi-phase coil groups that are arranged linearly and generate linear power in an arrangement direction depending on flowing multi-phase ACs, and inter-coil reinforcing members that are provided between the plurality of multi-phase coil groups.

According to this aspect, stiffness is increased by the inter-coil reinforcing members provided between the plurality of multi-phase coil groups.

According to another aspect of the present invention, there is provided a positioning device. This device uses the linear motor as a power source.

According to still another aspect of the present invention, there is provided a processing apparatus. This processing apparatus processes a workpiece positioned by the positioning device.

According to yet another aspect of the present invention, there is provided a device manufacturing method. This method manufactures a device through processing of the workpiece performed by the processing apparatus.

Any combination of the components described above and conversions of these expressions into methods, devices, systems, recording mediums, computer programs, and the like are also included in the present invention.

### BRIEF DESCRIPTION OF THE DRAWINGS

FIG. 1 is a plan view schematically showing a stage device.

FIG. 2 is a perspective view showing an armature of a linear motor.

FIG. 3 is a cross-sectional view of the armature taken along a plane of which a normal direction is an arrangement direction of coil arrays.

FIG. 4 shows the arrangement of U, V, and W-phase coils of three-phase coil groups together with electrical angles of three-phase ACs.

### DETAILED DESCRIPTION

A mode (hereinafter, also referred to as an embodiment) for carrying out the present invention will be described in detail below with reference to the drawings. In the description and/or drawings, the same or equivalent components, members, processing, and the like are denoted by the same reference numerals, and the repeated description will be omitted. The scale and shape of each shown part are conveniently set to simplify description, and should not be interpreted as being limited unless otherwise specified. The embodiment is exemplary and does not limit the scope of the present invention in any way. All features and combinations thereof described in the embodiment are not necessarily limited to being essential to the present invention.

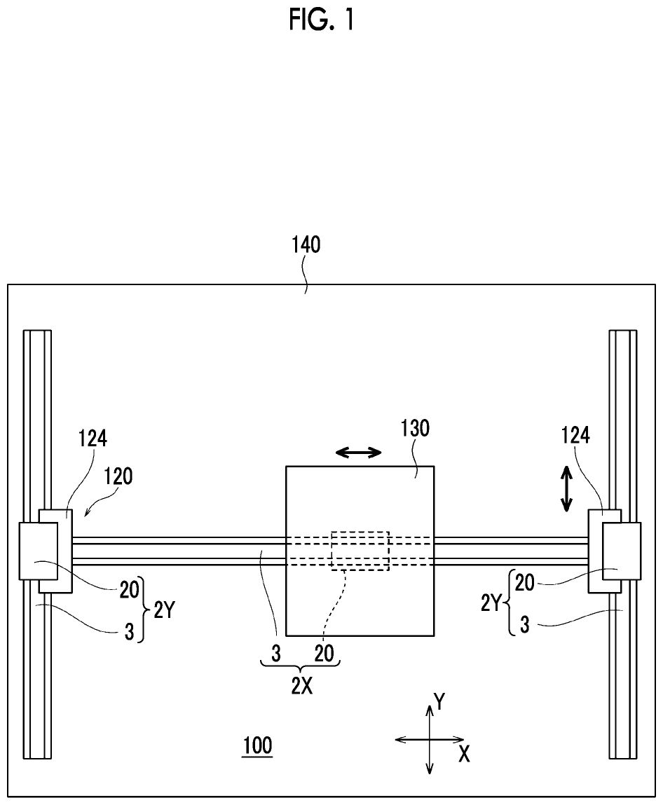

FIG. 1 is a plan view schematically showing a stage device 100 as a positioning device or a driving device to which a linear motor according to an embodiment of the present invention can be applied. The stage device 100 is an XY stage that positions a table as a driven body on which a workpiece, such as a semiconductor wafer, is to be placed in an X-axis direction (a horizontal direction in FIG. 1) and a Y-axis direction (a vertical direction in FIG. 1). The stage device 100 includes: a pair of Y stages 120 that extends in the Y-axis direction and drives the table in the Y-axis direction; an X stage 130 that is integrated with the table, extends in the X-axis direction, and drives the table in the X-axis direction; and a surface plate 140. The pair of Y stages 120 is connected to both ends of the X stage 130 in the X-axis direction via sliders 124. The Y stages 120 and the X stage 130 form an H shape in a top view.

Among the components of the stage device 100, at least the table, the Y stages 120, and the X stage 130 may be accommodated in a vacuum chamber of which the inside is kept in a vacuum state. In the present specification, the term “vacuum” refers to the state of a space that is filled with a gas having a pressure lower than the normal atmospheric pressure. Depending on a pressure region, the vacuum is classified into a low vacuum (100 kPa to 100 Pa), a medium vacuum (100 Pa to 0.1 Pa), a high vacuum (0.1 Pa to 10⁻⁵ Pa), an ultra-high vacuum (10⁻⁵ Pa to 10⁻⁸ Pa), an extreme ultra-high vacuum (10⁻⁸ Pa or less), and the like. The stage device 100 of the present embodiment may be used in any vacuum environment among the vacuums classified above. Further, the stage device 100 of the present embodiment may be used in a non-vacuum environment not corresponding to the vacuums classified above.

The X stage 130 and each Y stage 120 are provided with linear motors 2X and 2Y to be described later, respectively. Linear power in the X-axis direction or the Y-axis direction, which is generated by each of the linear motors 2X and 2Y, linearly drives the table as a driven body in the X-axis direction or the Y-axis direction. The linear motor 2X that is responsible for linear drive in the X-axis direction includes field magnets 3 that form a stator and a track extending in the X-axis direction, and a movable element 20 that is movable along the field magnets 3 in the X-axis direction. The table as a driven body is fixed to the movable element 20, and is moved integrally with the movable element 20. Each of the pair of linear motors 2Y that is responsible for linear drive in the Y-axis direction includes field magnets 3 that form a stator and a track extending in the Y-axis direction, and a movable element 20 that is movable along the field magnets 3 in the Y-axis direction. A slider 124 is fixed to the movable element 20, and is moved integrally with the movable element 20. Here, since the pair of sliders 124 are connected to both ends of an armature 2 of the linear motor 2X, the pair of linear motors 2Y linearly drives the armature 2 of the linear motor 2X and the pair of sliders 124 together in the Y-axis direction. Further, since the table is positioned on the armature 2 (track) of the linear motor 2X, the pair of linear motors 2Y linearly drives the table in the Y-axis direction.

The stage device 100 (a positioning device using the linear motor as a power source) of the present embodiment, which can realize highly accurate positioning or driving regardless of the vacuum environment and the non-vacuum environment as described above, is suitable to position and drive a table, on which semiconductor wafers or the like as workpieces are to be placed, as a driven body in, for example, semiconductor manufacturing apparatuses, such as an exposure apparatus, an ion implanter, a heat treatment apparatus, an ashing apparatus, a sputtering apparatus, a dicing apparatus, an inspection apparatus, and a cleaning apparatus, and a device manufacturing apparatus, such as a flat panel display (FPD) manufacturing apparatus. A processing apparatus to which the stage device 100 of the present embodiment can be applied may be any apparatus that positions any workpiece using the stage device 100 or the positioning device to process the workpiece, and may be, for example, any manufacturing apparatus, any machining apparatus (for example, a machine tool), or any inspection apparatus.

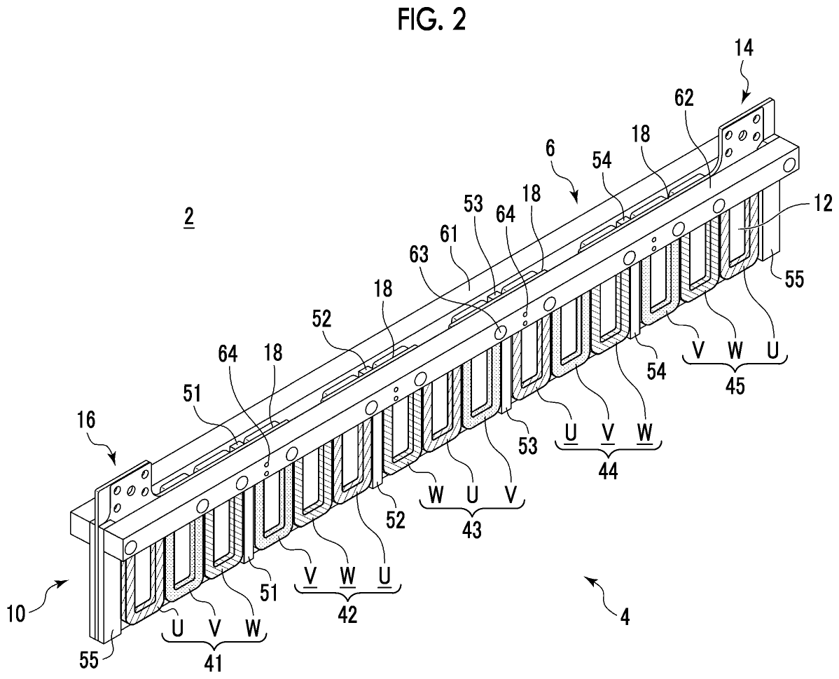

FIG. 2 is a perspective view showing the armature of each of the linear motors 2X and 2Y that are provided in the X stage 130 and the Y stages 120, respectively. The linear motor includes the field magnets 3 (FIG. 1) that are formed of permanent magnets or electromagnets, and the armature 2 that is formed of a plurality of coils 4. The armature 2 has the shape of a long substantially rectangular plate, and a coil array including the plurality of coils 4 is formed on each of both a first surface side thereof (for example, a back side of the armature 2 in FIG. 2) and a second surface side thereof (for example, a front side of the armature 2 in FIG. 2). Each coil array includes the plurality of coils 4 that are arranged along a longitudinal direction of the armature 2 (a substantially horizontal direction in FIG. 2). Since each coil array includes 15 coils 4 in the example shown in FIG. 2, the 15 coils 4 are classified into five sets of three-phase coil groups 41, 42, 43, 44, and 45 in a case where three-phase ACs are applied to each coil array.

Each of the three-phase coil groups 41 to 45 includes a U-phase coil (shown as “U” or “U/” (“/” represents an underline)), a V-phase coil (shown as “V” or “V/”), and a W-phase coil (shown as “W” or “W/”) that are arranged linearly. In a case where the phase or the electrical angle of a U-phase current flowing through the U-phase coil “U” is set to “0°”, a V-phase current having a phase of “240°” flows through the V-phase coil “V” and a W-phase current having a phase of “120°” flows through the W-phase coil “W”. Further, a reverse U-phase current having a phase of “180°” opposite to the phase of the current flowing through the U-phase coil “U” flows through the reverse U-phase coil “U/”, a reverse V-phase current having a phase of “60°” opposite to the phase of the current flowing through the V-phase coil “V” flows through the reverse V-phase coil “V/”, and a reverse W-phase current having a phase of “300°” opposite to the phase of the current flowing through the W-phase coil “W” flows through the reverse W-phase coil “W/”.

In a general linear motor, a plurality of three-phase coil groups are arranged with substantially no gap and the arrangement of U, V, and W-phase coils of the respective three-phase coil groups is uniform in the order of a U-phase coil “U” (or “U/”), a V-phase coil “V” (or “V/”), and a W-phase coil “W” (or “W/”). On the other hand, since inter-coil reinforcing members 51, 52, 53, and 54 are provided between the three-phase coil groups 41 to 45 as described later in the linear motor according to the present embodiment, the arrangement of the U, V, and W-phase coils of the respective three-phase coil groups 41 to 45 is not uniform.

The field magnets 3 (FIG. 1) formed of permanent magnets or electromagnets face the coil arrays that are provided on the first surface and the second surface of the armature 2. Each coil array through which driving currents, such as three-phase ACs, flow applies linear power to the field magnet 3, which faces each coil array, and/or each coil array itself. A direction of this linear power is substantially the same as the arrangement direction of the respective coil arrays (that is, the longitudinal direction of the armature 2 or a substantially horizontal direction in FIG. 2), and the field magnets 3 and the armature 2 are linearly moved relative to each other in the direction. Any of the field magnets 3 and the armature 2 may be used as a movable element or a stator. That is, the field magnets 3 may be used as a movable element and the armature 2 may be used as a stator, the field magnets 3 may be used as a stator and the armature 2 may be used as a movable element, or both the field magnets 3 and the armature 2 may be used as a movable element.

Further, the field magnets 3 facing the coil arrays formed on the first surface side and the second surface side of the armature 2 may be connected to each other or may be integrally formed, so that both the field magnets 3 may be integrally driven relative to the armature 2 by the coil arrays formed on both sides of the armature 2. In this case, substantially the same driving current is applied to each coil 4 provided on the first surface side of the armature 2 and each coil 4 provided on the second surface side positioned substantially behind the coil 4. Alternatively, different driving currents may be applied to the coil arrays formed on the first surface side and the second surface side of the armature 2 so that the field magnet 3 provided on the first surface side and the field magnet 3 provided on the second surface side are driven independently of each other.

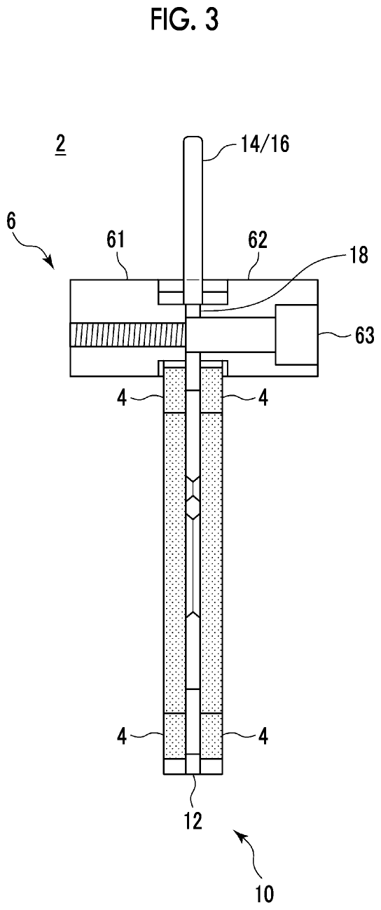

A cooling member 10, which cools the plurality of coils 4 of the armature 2, is interposed between the coil array provided on the first surface side of the armature 2 and the coil array provided on the second surface side thereof. The cooling member 10 has the shape of a long substantially rectangular plate, and is disposed such that one end surfaces or inner end surfaces (right end surfaces of the left coils 4 and left end surfaces of the right coils 4 in FIG. 3) of the respective coil arrays are in contact with both a first surface and a second surface of the cooling member 10 (a left surface and a right surface of a cooling plate 12 in FIG. 3 to be described later). The cooling member 10 includes the cooling plate 12 that supports the coil arrays on the respective surfaces thereof and has the shape of a substantially rectangular plate, an inflow portion 14 that is provided at one end portion of the cooling plate 12 in the arrangement direction of the coils 4, and an outflow portion 16 that is provided at the other end portion of the cooling plate 12 in the arrangement direction of the coils 4. The inflow portion 14 and the outflow portion 16 may be reversed (that is, a direction in which a refrigerant to be described later flows may be reversed, the inflow portion 14 may be made to function as an outflow portion, and the outflow portion 16 may be made to function as an inflow portion).

The inflow portion 14 is provided at a position deviated from the arrangement direction of the coils 4, specifically, above the coil 4 that is positioned at one end (a right end in FIG. 2) of the coil array. In the present specification, terms, such as “above” and “below”, are to conveniently indicate a relative positional relationship between the coil array or the coil 4 and the inflow portion 14 or the like with reference to the drawings, and do not mean above and below in a vertical direction or the direction of gravity. Hereinafter, unless otherwise specified, terms indicating directions, such as “upper”, “lower”, “left”, and “right”, mean a relative direction with respect to the coil array or the coil 4 shown in each drawing. A refrigerant, such as cooling water, for cooling the plurality of coils 4 flows into the inflow portion 14. A flow channel that allows the refrigerant having flowed in from the inflow portion 14 to flow from one end side to the other end side of the coil array is formed in the cooling member 10 (particularly, the flat plate-shaped cooling plate 12). As with the inflow portion 14, the outflow portion 16 is provided at a position deviated from the arrangement direction of the coils 4, specifically, above the coil 4 that is positioned at the other end (a left end in FIG. 2) of the coil array. The refrigerant, which has flowed in from the inflow portion 14 and flowed through the flow channel formed in the cooling member 10, flows out of the outflow portion 16.

The refrigerant flowing through the flow channel formed in the cooling member 10 as described above simultaneously cools the two coil arrays that are disposed in contact with both the surfaces of the flat plate-shaped cooling plate 12. The coil array may be provided on only one surface of the flat plate-shaped cooling plate 12. In this case, the refrigerant flowing through the flow channel formed in the cooling member 10 cools one coil array that is disposed in contact with one surface of the flat plate-shaped cooling plate 12.

The columnar inter-coil reinforcing members 51 to 54 for increasing the stiffness of the armature 2 are provided between the respective three-phase coil groups 41 to 45 that are formed of the U, V, and W-phase coils 4 adjacent to each other in the arrangement direction. Further, columnar end portion-reinforcing members 55 for increasing the stiffness of the armature 2 are provided at both end portions in the arrangement direction of the coil arrays, which are formed of the plurality of three-phase coil groups 41 to 45 (the longitudinal direction of the armature 2). The inter-coil reinforcing members 51 to 54 and the end portion-reinforcing members 55 are attached to the cooling plate 12 of the cooling member 10 or are formed integrally with the cooling plate 12.

As also shown in FIG. 3 that is a cross-sectional view of the armature 2 taken along a plane of which a normal direction is the arrangement direction of the coil arrays, the cooling member 10 includes supported portions 18 that further extend to an outer peripheral side (an upper side in FIG. 3) than the coils 4 provided on both surfaces (a left surface and a right surface in FIG. 3) of the cooling member 10. As shown in FIG. 2, one or a plurality of supported portions 18 are continuously or intermittently provided in the arrangement direction of the coils 4.

One or a plurality of supported portions 18 (and the inflow portion 14 and the outflow portion 16) are supported from both surfaces by a support member 6 or a holder. The support member 6 includes: a first support body 61 that is in contact with first surfaces (left surfaces in FIG. 3) of the supported portions 18; a second support body 62 that is in contact with second surfaces (right surfaces in FIG. 3) of the supported portions 18; and fixing tools 63 such as screws that are inserted into fixing holes, such as screw holes provided to penetrate the first support body 61, the supported portions 18 (and the inflow portion 14 and the outflow portion 16), and the second support body 62 and integrally fix the first support body 61, the supported portions 18, and the second support body 62. As shown in FIG. 2, the first support body 61 and the second support body 62 extend over substantially the entire length of the armature 2, and are firmly fixed by the plurality of fixing tools 63 in a state where the inflow portion 14 and the outflow portion 16 provided at both end portions of the armature 2 and all the supported portions 18 provided between the inflow portion 14 and the outflow portion 16 are sandwiched between the first support body 61 and the second support body 62.

Further, as shown in FIG. 2, the first support body 61 and the second support body 62 fix not only the supported portions 18 but also upper portions of the inter-coil reinforcing members 51 to 54 in a state where not only the supported portions 18 but also upper portions of the inter-coil reinforcing members 51 to 54 are sandwiched between the first support body 61 and the second support body 62. Fixing tools 64, such as screws, for fixing the inter-coil reinforcing members 51 to 54 are attached to the first support body 61 and/or second support body 62.

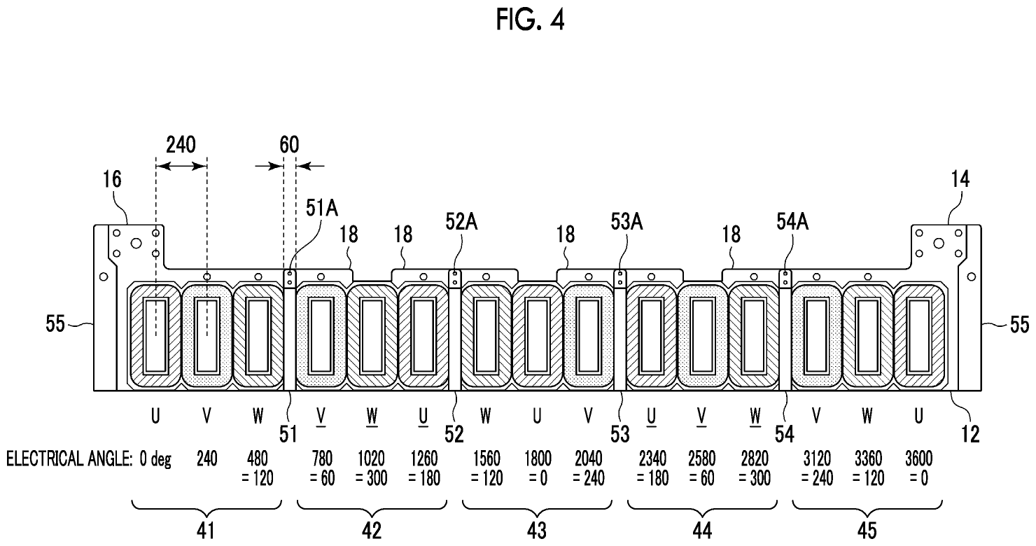

FIG. 4 shows the arrangement of the U, V, and W-phase coils of the three-phase coil groups 41 to 45 according to the present embodiment together with electrical angles (phases) of three-phase ACs. In the example shown in FIG. 4, it is assumed that an interval in the arrangement direction (a horizontal direction in FIG. 4) between two coils 4 (for example, the U-phase coil “U” and the V-phase coil “V” of the three-phase coil group 41) adjacent to each other with no gap is “240°” in terms of an electrical angle.

Between the respective three-phase coil groups 41 to 45, spaces having a width equal to “60°” in terms of an electrical angle are provided and the inter-coil reinforcing members 51 to 54 having a width equal to or less than the width are provided. That is, since jump in an electrical angle of “60°” occurs between the three-phase coil groups 41 to 45, an intended phase relationship of three-phase ACs is not realized in a case where the arrangement of the U, V, and W-phase coils of the respective three-phase coil groups 41 to 45 is uniform as in a general linear motor. Accordingly, in the present embodiment, the arrangement order of the U-phase coil “U” or “U/”, the V-phase coil “V” or “V/”, and the W-phase coil “W” or “W/” is different in two of the three-phase coil groups 41 to 45 which are adjacent to each other in the arrangement direction via the inter-coil reinforcing members 51 to 54 and through which three-phase ACs having phases opposite to each other flow.

For example, regarding two three-phase coil groups 41 and 42 which are adjacent to each other in the arrangement direction via the inter-coil reinforcing member 51 and through which three-phase ACs having phases opposite to each other flow, the U-phase coil “U” (0°), the V-phase coil “V” (240°), and the W-phase coil “W” (120°) are arranged in order in the first three-phase coil group 41, and the V-phase coil “V/” (60°), the W-phase coil “W/” (300°), and the U-phase coil “U/” (180°) are arranged in order in the second three-phase coil group 42.

Further, regarding two three-phase coil groups 42 and 43 which are adjacent to each other in the arrangement direction via the inter-coil reinforcing member 52 and through which three-phase ACs having phases opposite to each other flow, the V-phase coil “V/” (60°), the W-phase coil “W/” (300°), and the U-phase coil “U/” (180°) are arranged in order in the second three-phase coil group 42, and the W-phase coil “W” (120°), the U-phase coil “U” (0°), and the V-phase coil “V” (240°) are arranged in order in the third three-phase coil group 43.

Furthermore, regarding two three-phase coil groups 43 and 44 which are adjacent to each other in the arrangement direction via the inter-coil reinforcing member 53 and through which three-phase ACs having phases opposite to each other flow, the W-phase coil “W” (120°), the U-phase coil “U” (0°), and the V-phase coil “V” (240°) are arranged in order in the third three-phase coil group 43, and the U-phase coil “U/”) (180°), the V-phase coil “V/” (60°), and the W-phase coil “W/”) (300°) are arranged in order in the fourth three-phase coil group 44.

Moreover, regarding two three-phase coil groups 44 and 45 which are adjacent to each other in the arrangement direction via the inter-coil reinforcing member 54 and through which three-phase ACs having phases opposite to each other flow, the U-phase coil “U/” (180°), the V-phase coil “V/” (60°), and the W-phase coil “W/” (300°) are arranged in order in the fourth three-phase coil group 44, and the V-phase coil “V” (240°), the W-phase coil “W” (120°), and the U-phase coil “U” (0°) are arranged in order in the fifth three-phase coil group 45.

Since the arrangement of the U, V, and W-phase coils of the three-phase coil groups 41 to 45 is intentionally made non-uniform as described above, an intended phase relationship of three-phase ACs can be realized even in a case where the inter-coil reinforcing members 51 to 54 are interposed between the respective three-phase coil groups 41 to 45. Therefore, according to the present embodiment, intended linear drive as a linear motor can be realized while the stiffness of the armature 2 can be increased by the inter-coil reinforcing members 51 to 54. Further, since not only the inter-coil reinforcing members 51 to 54 but also the end portion-reinforcing members 55 and the support member 6 are provided in the present embodiment, the stiffness of the armature 2 is further increased.

The width of each of spaces in which the inter-coil reinforcing members 51 to 54 are provided between the respective three-phase coil groups 41 to 45 is equal to “60°” in terms of an electrical angle in the example shown in FIG. 4, but may be equal to a natural number multiple of “60°”. In a case where the width of each space is changed, the amount of jump in an electrical angle between the three-phase coil groups 41 to 45 is also changed. However, in a case where the arrangement of the U, V, and W-phase coils of the respective three-phase coil groups 41 to 45 is adjusted as appropriate as in the example shown in FIG. 4, an intended phase relationship (for example, U=0, V=240, W=120, U/=180, V/=60, and W/=300) of three-phase ACs can be realized.

Further, the inter-coil reinforcing members 51 to 54 are provided between all (four) pairs of three-phase coil groups among the three-phase coil groups 41 to 45 in the example shown in FIG. 4, but the inter-coil reinforcing members 51 to 54 may be provided between at least one pair of three-phase coil groups among the three-phase coil groups 41 to 45. However, in a case where the inter-coil reinforcing members 51 to 54 are provided between all pairs of three-phase coil groups among the three-phase coil groups 41 to 45 as in the example shown in FIG. 4, the inter-coil reinforcing members 51 to 54 increase the stiffness of the armature 2 in balance over substantially the entire length of the armature 2 together with the end portion-reinforcing members 55 provided at both end portions of the armature 2. In the long armature 2 as in the present embodiment, undesired natural vibration having various modes or orders may occur in the longitudinal direction but is effectively suppressed by the inter-coil reinforcing members 51 to 54 arranged in balance at regular intervals in the longitudinal direction.

The present invention has been described above on the basis of the embodiments. Various modification examples are possible in the combinations of each component and each processing in the embodiment provided as an example, and it is obvious to those skilled in the art that such modification examples are included in the scope of the present invention.

Although the linear motor including the plurality of three-phase coil groups 41 to 45 through which three-phase ACs flow has been described in the embodiment, the present invention can also be applied to a linear motor including a plurality of multi-phase coil groups through which multi-phase ACs having, for example, phases more than three phases flow.

The configuration, action, and function of each device and each method described in the embodiment can be realized by hardware resources or software resources or the cooperation of hardware resources and software resources. For example, a processor, a ROM, a RAM, and various integrated circuits can be used as the hardware resources. For example, programs, such as an operating system and an application, can be used as the software resources.

It should be understood that the invention is not limited to the above-described embodiment, but may be modified into various forms on the basis of the spirit of the invention. Additionally, the modifications are included in the scope of the invention.

What is claimed is:

1. A linear motor comprising:
a plurality of multi-phase coil groups that are arranged linearly and generate linear power in an arrangement direction depending on flowing multi-phase ACs; and
inter-coil reinforcing members that are provided between the plurality of multi-phase coil groups.

2. The linear motor according to claim 1,
wherein a width of a space, in which the inter-coil reinforcing member is provided, in the arrangement direction is equal to a natural number multiple of 60° in terms of an electrical angle of the multi-phase AC.

3. The linear motor according to claim 1,
wherein each of the multi-phase coil groups is a three-phase coil group that includes a U-phase coil, a V-phase coil, and a W-phase coil arranged linearly and generates linear power in the arrangement direction depending on flowing three-phase ACs, and
an arrangement order of the U-phase coil, the V-phase coil, and the W-phase coil is different in two three-phase coil groups which are adjacent to each other in the arrangement direction via the inter-coil reinforcing member and through which the three-phase ACs having phases opposite to each other flow.

4. The linear motor according to claim 3,
wherein a width of a space, in which the inter-coil reinforcing member is provided, in the arrangement direction is equal to 60° in terms of an electrical angle of the three-phase AC, and
regarding the two three-phase coil groups which are adjacent to each other in the arrangement direction via the inter-coil reinforcing member and through which the three-phase ACs having phases opposite to each other flow, the U-phase coil, the V-phase coil, and the W-phase coil are arranged in order in a first three-phase coil group, and the V-phase coil, the W-phase coil, and the U-phase coil are arranged in order in a second three-phase coil group.

5. The linear motor according to claim 1, further comprising:
end portion-reinforcing members that are provided at both end portions in the arrangement direction of the plurality of multi-phase coil groups.

6. The linear motor according to claim 1, further comprising:
a cooling member that is provided on one end surfaces of the plurality of multi-phase coil groups and cools the plurality of multi-phase coil groups.

7. The linear motor according to claim 6,
wherein the plurality of multi-phase coil groups are provided on both surfaces of the cooling member.

8. The linear motor according to claim 7,
wherein the cooling member includes a supported portion that further extends to an outer peripheral side than the plurality of multi-phase coil groups provided on the both surfaces of the cooling member, and
a support member that supports both surfaces of the supported portion.

9. A positioning device that uses the linear motor according to claim 1 as a power source.

10. A processing apparatus that processes a workpiece positioned by the positioning device according to claim 9.

11. A device manufacturing method of manufacturing a device through processing of the workpiece performed by the processing apparatus according to claim 10.
